(19) United States
(12) Patent Application Publication
(10) Pub. No.: US 2014/0098785 A1
(43) Pub. Date: Apr. 10, 2014

(54) METHODS AND APPARATUSES FOR AN EXTENDED BANDWIDTH CARRIER

(71) Applicant: Telefonaktiebolaget L M Ericsson (publ), Stockholm (SE)

(72) Inventors: Mattias Frenne, Uppsala (SE); Robert Baldemair, Solna (SE); Jung-Fu Cheng, Fremont, CA (US); Dirk Gerstenberger, Vallentuna (SE); Havish Koorapaty, Saratoga, CA (US); Daniel Larsson, Vallentuna (SE)

(73) Assignee: Telefonaktiebolaget L M Ericsson (publ), Stockholm (SE)

(21) Appl. No.: 14/124,938

(22) PCT Filed: Jul. 4, 2011
(86) PCT No.: PCT/SE2011/050900

§ 371 Date: Dec. 9, 2013

(51) Int. Cl. H04W 72/04

(52) U.S. Cl. CPC H04W 72/042
USPC 370/330

(57) ABSTRACT

Apparatuses and methods allow for uplink selection using an extended bandwidth carrier. A user equipment (UE) comprises: a transceiver configured to receive control signaling on an extended bandwidth carrier, the extended bandwidth carrier having a first control region disposed within a legacy bandwidth, and a second control region including additional resource blocks disposed outside of the legacy bandwidth, wherein the transceiver can receive the control signaling in either or both of the first control region and the second control region.

### TECHNICAL FIELD

The present invention relates generally to telecommunications systems, and in particular, to methods, systems, devices and software for using an extended bandwidth carrier.

### BACKGROUND

Radiocommunication networks were originally developed primarily to provide voice services over circuit-switched networks. The introduction of packet-switched bearers in, for example, the so-called 2.5G and 3G networks enabled network operators to provide data services as well as voice services. Eventually, network architectures will likely evolve toward all Internet Protocol (IP) networks which provide both voice and data services. However, network operators have a substantial investment in existing infrastructures and would, therefore, typically prefer to migrate gradually to all IP network architectures in order to allow them to extract sufficient value from their investment in existing infrastructures. Also to provide the capabilities needed to support next generation radiocommunication applications, while at the same time using legacy infrastructure, network operators could deploy hybrid networks wherein a next generation radiocommunication system is overlaid onto an existing circuit-switched or packet-switched network as a first step in the transition to an all IP-based network. Alternatively, a radiocommunication system can evolve from one generation to the next while still providing backward compatibility for legacy equipment.

One example of such an evolved network is based upon the Universal Mobile Telephone System (UMTS) which is an existing third generation (3G) radiocommunication system that is evolving into High Speed Packet Access (HSPA) technology. Yet another alternative is the introduction of a new air interface technology in E-UTRAN, wherein Orthogonal Frequency Division Multiple Access (OFDMA) technology is used in the downlink and single carrier frequency division multiple access (SC-FDMA) in the uplink. In both uplink and downlink the data transmission is split into several sub-streams, where each sub-stream is modulated on a separate sub-carrier. Hence in OFDMA based systems, the available bandwidth is sub-divided into several resource blocks (RB) as defined, for example, in 3GPP TR 25.814: “Physical Layer Aspects for Evolved UTRA”. According to this document, a resource block is defined in both time and frequency. A physical resource block size is 180 KHz and 1 time slot (0.5 ms) in frequency and time domains, respectively. The overall uplink and downlink transmission bandwidth in a single carrier LTE system can be as large as 20 MHz.

An E-UTRA system under single carrier operation may be deployed over a wide range of bandwidths, e.g. 1.25, 2.5, 5, 10, 15, 20 MHz, etc. As an example a 10 MHz bandwidth would contain 50 resource blocks. For data transmission the network can allocate variable number of RB to the UE both in the uplink and downlink. This allows more flexible use of channel bandwidth since it is allocated according to the amount of data to be transmitted, radio conditions, UE capability, scheduling scheme etc. In addition the neighboring cells, even on the same carrier frequency, may have different channel bandwidths.

Multi-carrier (also known as the carrier aggregation (CA)), refers to the situation where two or more component carriers (CC) are aggregated for the same UE. CA enables manifold increase in the downlink and uplink data rate. For example, it is possible to aggregate different number of component carriers of possibly different bandwidths in the UL and the DL.

Carrier aggregation thus allows the UE to simultaneously receive and transmit data over more than one carrier frequency. Each carrier frequency is generally called a component carrier. This enables a significant increase in data reception and transmission rates. For instance 2×20 MHz aggregated carriers would theoretically lead to two fold increase in data rate compared to that attained by a single 20 MHz carrier. The component carrier may be contiguous or non-contiguous. Furthermore in case of non-contiguous carriers, they may belong to the same frequency band or to different frequency bands. This is often referred to as inter-band CA.

LTE uses OFDM in the downlink and DFT-spread OFDM in the uplink. The basic LTE downlink physical resource can thus be seen as a time-frequency grid 2 as illustrated in FIG. 1, where each resource element 4 corresponds to one OFDM subcarrier 6 during one OFDM symbol interval. In the time domain, LTE downlink transmissions are organized into radio frames of 10 ms as shown in FIG. 2, each radio frame 8 consisting of ten equally-sized subframes 10 of length T_{subframe}=1 ms. Furthermore, the resource allocation in LTE is typically described in terms of resource blocks (RB), where a resource block corresponds to one slot (0.5 ms) in the time domain and 12 contiguous subcarriers in the frequency domain. A pair of two adjacent resource blocks in time direction (1.0 ms) is known as a resource block pair. Resource block pairs are numbered in the frequency domain, starting with 0 from one end of the system bandwidth.

The notion of virtual resource blocks (VRB) and physical resource blocks (PRB) has been introduced in LTE. The actual resource allocation to a UE is made in terms of VRB pairs. There are two types of resource allocations, localized and distributed. In the localized resource allocation, a VRB pair is directly mapped to a PRB pair, hence two consecutive and localized VRBs are also placed as consecutive PRBs in the frequency domain. On the other hand, the distributed VRBs are not mapped to consecutive PRBs in the frequency domain, thereby providing frequency diversity for data channel transmitted using these distributed VRBs.

Downlink transmissions are dynamically scheduled, i.e., in each subframe the base station transmits control information about to which terminals data is transmitted and upon which resource blocks the data is transmitted, in the current downlink subframe. This control signalling is typically transmitted in the first 1, 2, 3 or 4 OFDM symbols in each subframe and the number n=1, 2, 3 or 4 is known as the Control Format Indicator (CFI). The downlink subframe also contains common reference symbols (CRS), which are known to the receiver and used for coherent demodulation of e.g. the control information. A downlink (DL) system 12 with CFI-3 OFDM symbols as control is illustrated in FIG. 3.

The LTE Rel-10 specifications have recently been standardized, supporting CC bandwidths up to 20 MHz (which is the maximal LTE Rel-8 carrier bandwidth). Hence, an LTE Rel-10 operation wider than 20 MHz is possible and can appear as a number of LTE carriers to an LTE Rel-10 terminal. In particular for early LTE Rel-10 deployments it can be expected that there will be a smaller number of LTE Rel-10-capable terminals compared to many LTE legacy terminals. Therefore, it is necessary to assure an efficient use of a wide carrier also for legacy terminals, i.e. that it is possible to implement carriers where legacy terminals can be scheduled in all parts of the wideband LTE Rel-10 carrier. The straightforward way to obtain this would be by means of CA. CA implies that an LTE Rel-10 terminal can receive multiple CCs, where the CCs have, or at least the possibility to have, the same structure as a Rel-8 carrier. An example of CA is illustrated in FIG. 4 which shows an aggregated bandwidth of 100 MHz 14 which can be achieved by using five 20 MHz carriers 16, all of which are contiguous.

The LTE Rel-10 standard supports up to five aggregated carriers where each carrier is limited in the RF specifications to have a one of six bandwidths namely 6, 15, 25, 50, 75 or 100 RB (corresponding to 1.4, 3, 5, 10, 15 and 20 MHz respectively). The number of aggregated CCs as well as the bandwidth of the individual CC may be different for uplink (UL) and DL. A symmetric configuration refers to the case where the number of CCs in downlink and uplink is the same whereas an asymmetric configuration refers to the case that the number of CCs is different. The number of CCs configured in the network may be different from the number of CCs seen by a terminal (or user equipment). A terminal may, for example, support more downlink CCs than uplink CCs, even though the network offers the same number of uplink and downlink CCs.

During initial access a LTE Rel-10 terminal behaves similar to a LTE Rel-8 terminal. Upon successful connection to the network a terminal may, depending on its own capabilities and the network, be configured with additional CCs in the UL and DL. Configuration is based on radio resource control (RRC). Due to the heavy signaling and rather slow speed of RRC signaling it is envisioned that a terminal may be configured with multiple CCs even though not all of them are currently used. If a terminal is activated on multiple CCs this would imply it has to monitor all DL CCs for PDCCH and PDSCH. This implies a wider receiver bandwidth, higher sampling rates, etc. resulting in high power consumption.

There have been discussions in 3GPP on variants of a component carrier, such as carrier segments. A carrier segment is a carrier extension with one or multiple non-backward compatible bandwidth parts which are contiguous with the component carrier they are associated with. Scheduling a terminal in a carrier segment takes place by a single PDCCH that can address any resource blocks in the backward compatible part plus the associated segment(s).

The available spectrum is in reality fragmented into (sometimes adjacent) bandwidth pieces with a large number of different bandwidths (for example 1.25, 2, 2.5, 3.75, 6, 12 and 18 MHz) that do not in general match the currently six supported legacy bandwidths in Rel-8: 1.4, 3, 5, 10, 15 and 20 MHz. It is therefore a problem how to utilize fragmented spectrum pieces and fully utilize new carrier bandwidths and still maintain backward compatibility to legacy UEs. Using carrier segments has been proposed as a possible solution to solve these issues. However, when introducing carrier segments, there are further problems. For example, the capacity of the physical downlink control channel (PDCCH) will be a bottleneck in utilizing the available extended bandwidth using a solution which carrier segments provide. This issue is exaggerated by the new system bandwidth (with segments) which is large when compared to the backward compatible bandwidth (without segments).

Furthermore, since legacy terminals and new terminals will see different effective bandwidths when one or multiple segments are introduced, it is a problem how to address (enumerate) the resource blocks in, e.g., the physical downlink shared channel (PDSCH) or physical uplink shared channel (PUSCH) scheduling of the shared data channel with a common RB enumeration method.

Accordingly, it would be desirable to develop other methods, devices, systems and software for improving communications.

### SUMMARY

Exemplary embodiments describe using an extended bandwidth carrier and allowing new and legacy user equipment (UEs) to operate together. By using an extended bandwidth carrier as described in exemplary embodiments, the new and legacy UEs can be scheduled without restrictions using a same resource allocation method. This can be achieved by using the additional resource blocks which are added to a legacy bandwidth and by putting control signaling into regions of the extended bandwidth carrier other than the legacy control bandwidth.

According to an embodiment, there is a user equipment (UE) comprising: a transceiver configured to receive control signaling on an extended bandwidth carrier, the extended bandwidth carrier having a legacy bandwidth and additional resource blocks disposed outside of the legacy bandwidth and the extended bandwidth having: a first control region disposed within the legacy bandwidth; and a second control region disposed either within the legacy bandwidth or within the additional resource blocks, wherein the transceiver can receive the control signaling in either or both of the first control region and the second control region.

According to another embodiment, there is a method for a user equipment (UE) to use an extended carrier bandwidth, the method comprising: receiving, at a transceiver, control signaling on the extended bandwidth carrier, the extended bandwidth carrier having a legacy bandwidth and additional resource blocks disposed outside of the legacy bandwidth and the extended bandwidth having: a first control region disposed within the legacy bandwidth; and a second control region disposed either within the legacy bandwidth or within the additional resource blocks, wherein the transceiver can received the control signaling in either or both of the first control region and the second control region.

According to an embodiment, there is a base station comprising: a processor configured to determine a size of an extended bandwidth carrier for a user equipment (UE), wherein the extended bandwidth carrier has a legacy bandwidth and additional resource blocks disposed outside of the legacy bandwidth, further wherein the extended bandwidth carrier has: a first control region disposed within the legacy bandwidth; a second control region disposed either within the legacy bandwidth or within the additional resource blocks; and a communications interface configured to transmit control signaling toward the UE using at least one of a first and second control regions.

According to an embodiment, there is a method for a base station to use an extended bandwidth carrier, the method comprising: determining, by a processor, a size of an extended bandwidth carrier for a user equipment (UE), wherein the extended bandwidth carrier has a legacy bandwidth and additional resource blocks disposed outside of the legacy bandwidth, further wherein the extended bandwidth carrier has: a first control region disposed within the legacy bandwidth; and a second control region disposed either within the legacy bandwidth or within the additional resource blocks; and transmitting, by a communications interface, control signaling toward the UE using at least one of a first and second control regions.

### BRIEF DESCRIPTION OF THE DRAWINGS

Embodiments of the present invention will now be described, by way of example only, with reference to the attached Figures, wherein:

FIG. 1 illustrates a Long Term Evolution (LTE) downlink physical resource as a time-frequency grid;

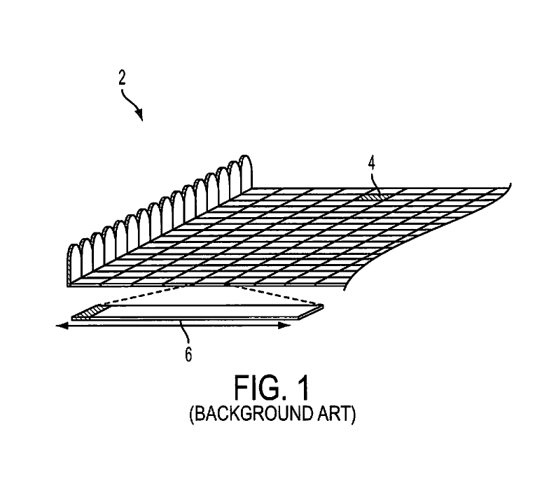

FIG. 2 shows a radio frame which includes ten subframes;

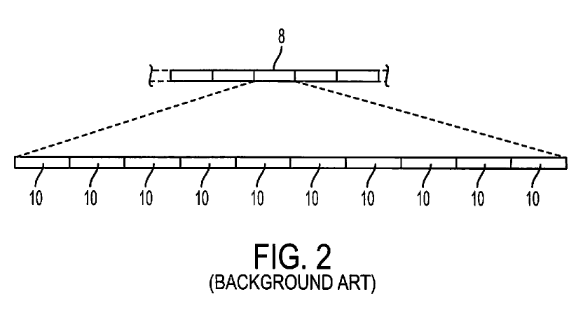

FIG. 3 illustrates a downlink system;

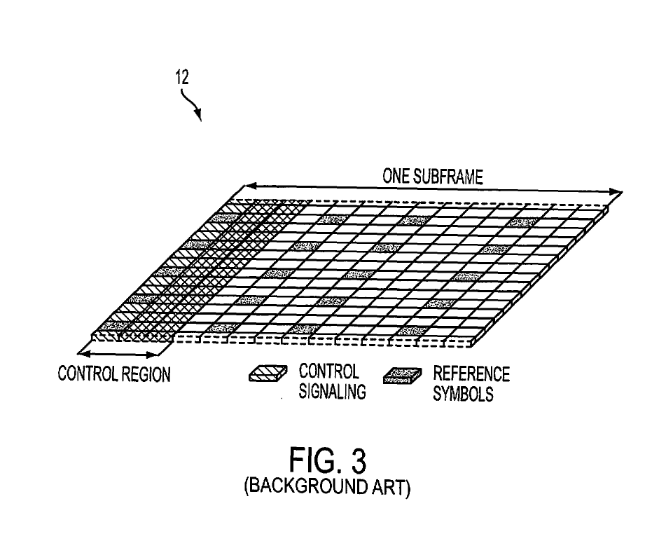

FIG. 4 depicts an aggregated bandwidth;

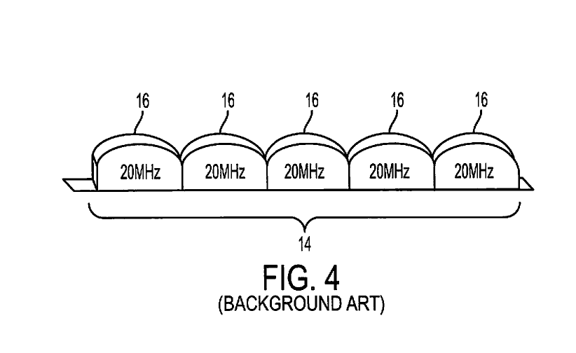

FIG. 5 shows an extended bandwidth carrier with a double sided extension according to exemplary embodiments;

FIG. 6 shows an extended bandwidth carrier with a single extension according to exemplary embodiments;

FIG. 7 illustrates a double sided extended bandwidth carrier with two slots in the uplink according to exemplary embodiments;

FIG. 8 shows an extended bandwidth carrier where with a plurality of downlink control regions according to exemplary embodiments;

FIG. 9 illustrates a numbering scheme for a plurality of physical resource block (PRB) pairs according to exemplary embodiments;

FIG. 10 shows scheduling when using a wrap around numbering scheme according to exemplary embodiments;

FIG. 11 depicts an alternative wrap around numbering scheme according to exemplary embodiments;

FIG. 12 shows two legacy bandwidth carriers embedded within an extended bandwidth carrier according to exemplary embodiments;

FIG. 13 depicts a PRB numbering scheme for an extended bandwidth carrier with two legacy carriers according to exemplary embodiments;

FIG. 14 illustrates an extended bandwidth carrier with two legacy carriers each of which has two associated extended regions according to exemplary embodiments;

FIG. 15 shows a base station communicating with a new UE and a legacy UE according to exemplary embodiments;

FIG. 16 is a flow chart illustrating a method for using an extended bandwidth carrier according to exemplary embodiments;

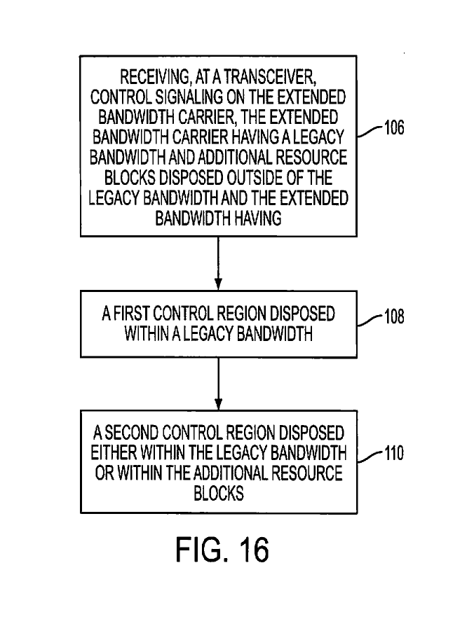

FIG. 17 depicts a user equipment according to exemplary embodiments;

FIG. 18 depicts a base station according to exemplary embodiments; and

FIG. 19 is a flow chart illustrating a method for a base station to use an extended bandwidth carrier according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

According to exemplary embodiments, a new (non-legacy) terminal can operate and use parts of, or an entire extended bandwidth carrier and also read control channel information transmitted outside the legacy control channel region. The enumeration of the resource blocks (RBs) in the legacy and the extended region or regions, i.e., segments, can be constructed so that legacy and novel terminals can have a common RB numbering scheme in the legacy region and a continuation of the RB numbering scheme in extended regions such that the numbering is not constrained by the number of, or placement of, added segments.

Prior to describing the various exemplary embodiments in more detail, concepts for supporting the various exemplary embodiments are now described. A carrier can be defined with one or multiple legacy regions and one or multiple new (non-backward compatible) regions/segments. Two classes of user equipment (UE) (or user terminals) can be described with the legacy UEs being the first class and so-called “new UEs” being the second class, where the legacy UEs correspond, in third Generation Partnership Project (3GPP) terms, to Release 8, 9 or 10 UEs. The new UEs belong to a release later than Release 10. An extended carrier can be obtained by adding additional resource blocks on one or both sides of a legacy carrier bandwidth, to obtain a larger carrier through a single or double sided extension respectively. Fragmented spectrum pieces or system bandwidths that are not part of the set of six supported legacy bandwidths can then be covered by a single extended carrier and legacy UEs can access this carrier in the corresponding legacy bandwidth.

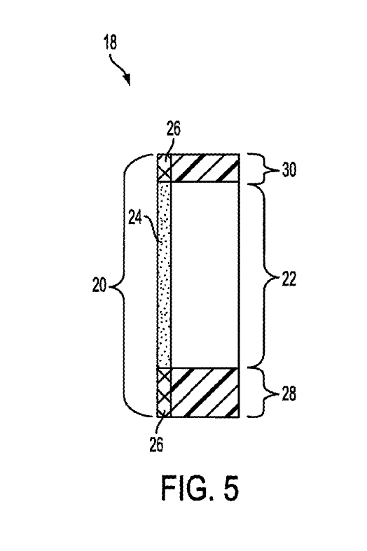

The legacy, e.g., Release 8, bandwidths are 6, 15, 25, 50, 75 or 100 RBs and legacy UEs will only “see” this bandwidth in uplink and downlink and receive its downlink control channel in the legacy control region within the legacy bandwidth. This can be seen in FIG. 5 which shows an extended bandwidth carrier 18. The extended bandwidth carrier 18 includes an extended bandwidth 20, which include a legacy bandwidth 22, a legacy control region 24 and additional control regions 26. Therefore, according to exemplary embodiments, the legacy UE can only see the legacy bandwidth 22 and the legacy control region 24 while a new UE can see the entire extended bandwidth carrier 18 and its components.

According to exemplary embodiments, a new, non-legacy UE can, in addition to operating in the legacy bandwidth, also utilize the extended region(s) (also known as segments) of the extended carrier and thereby have access to an extended bandwidth for data use, control reception and transmission. The extended bandwidth carrier can have a double sided extension for the downlink as shown in FIG. 5 by the extended regions, which include the additional resource blocks, 28 and 30. Both new UEs and legacy UEs can be addressed in the normal control region 24. The additional control region(s) 26 can be utilized by new UEs for full bandwidth control signaling.

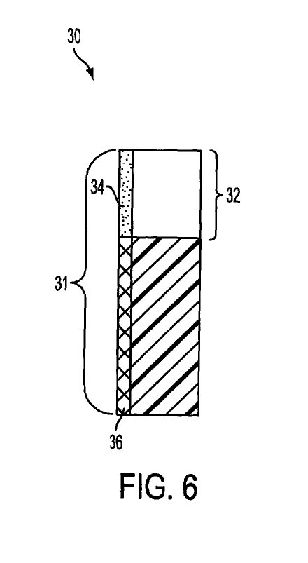

According to exemplary embodiments, there can be a single side extended bandwidth carrier for downlink where the legacy bandwidth is configured as comparably smaller than the extended bandwidth as shown in FIG. 6. FIG. 6 shows an extended bandwidth carrier 30 which includes an extended bandwidth 31 which includes a legacy bandwidth 32, a legacy control region 34 and an additional control region 36. This can be beneficial if the number of legacy terminals is outnumbered by the number of new terminals and an operator desires to only allocate a relative smaller portion of the extended bandwidth 31 to support legacy terminals. The legacy bandwidth 32 within the extended bandwidth 31 can be configurable to meet actual demands when terminal population migrates from legacy to new versions. Furthermore, one or all of the extended regions can be disabled and the system will then operate in a narrower, i.e., the legacy, bandwidth, which can be useful for, e.g., energy saving and/or interference pollution reduction. Additionally, the size of the extendable region(s) can be varied as desired.

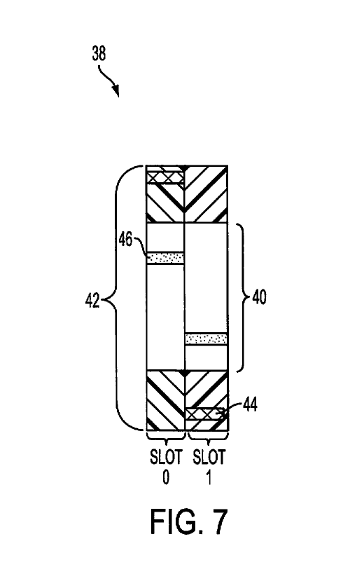

According to exemplary embodiments, FIG. 7 shows a double sided extended bandwidth carrier 38 with two slots in the uplink where a new UE may transmit its control information, e.g., physical uplink control channel (PUCCH), in either the legacy bandwidth 40 or in the new extended bandwidth 42. In this purely illustrative example, slot hopping of the alternative and new PUCCH 44 is adopted as for the legacy PUCCH 46. It is expected that the new UEs should only experience PUCCH interference from other new UEs and not from legacy UEs.

According to exemplary embodiments, the control region for new terminals may be an extension of the control region into the legacy region, i.e., a continuation of the first 1, 2, 3 or 4 orthogonal frequency division multiplexing (OFDM) symbols in each subframe into the extended region. This can be seen in FIGS. 5 and 6 where the control regions touch, e.g., control regions 24 and 26 touch in FIG. 5 and control regions 34 and 36 touch in FIG. 6. Since the bandwidth of the extended region of the carrier compared to the legacy bandwidth can be arbitrary, and the number of legacy UEs compared to the number of new UEs varies dynamically, the demand for control signalling resources in the additional control region also can vary dynamically.

According to an exemplary embodiment, a solution can be to use a static resource reservation, however this may lead to unnecessary resource reservation or resource shortage. According to another exemplary embodiment, it may be preferable to use a dynamic resource reservation and it can be possible to configure the resources, e.g., the number of OFDM symbols used for control in the extended region, separately from the number of OFDM symbols for control in the legacy region. If there is no need to use additional control resources in the extended region, which are accessible only for new terminals, then it is possible to disable the use of control symbols in the extended region. The related configuration signalling for the additional control region(s) may take place in the legacy control region since the legacy region is always accessible.

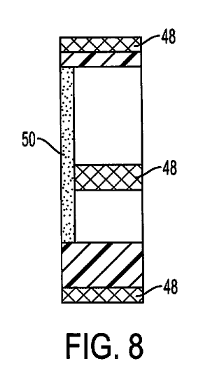

According to an alternative exemplary embodiment, the additional control region could be placed elsewhere in the extended bandwidth carrier where the new UE can receive it without interfering with legacy UEs. An example of this can be seen in FIG. 8 where the downlink control region(s) 48 have been placed at the extended band edges or placed somewhere in the data region of the legacy system operation while the legacy control region 50 is in a more conventional location. This approach can allow for new UEs to operate with a bandwidth in-between legacy carrier bandwidth and the full bandwidth of the extended carrier, as long as the new UE's associated control and data signaling is within the monitored bandwidth. If a new UE is not required to read control information from the legacy region this approach can also enable bandwidths less wide than only the extension regions.

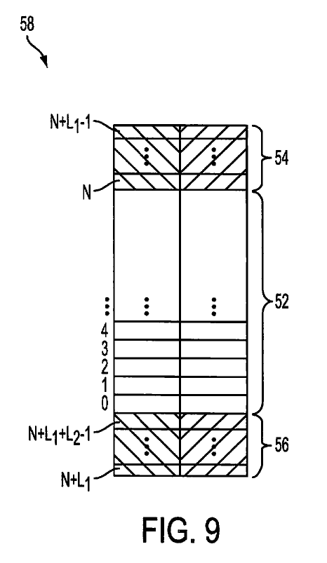

According to exemplary embodiments, physical resource block (PRB) pairs can be numbered to provide a common reference in a system for scheduling purposes. To ensure backward compatibility and joint operation of legacy and new UEs a common reference can be used for scheduling. Exemplary embodiments can include common PRB pair numbering of the carrier in the legacy bandwidth and to continue this numbering continuously in the extended regions in a predefined manner. As shown in FIG. 9, numbering of the N PRB pairs in the legacy bandwidth 52 starts with 0 and continues to N−1. In the first extended region side 54 the first PRB pair continues the sequence and can be assigned the number N. The numbering sequence for the PRB pairs in the first extended region side 54 continues to N+L₁−1 where it has been assumed that there are L₁ PRB pairs in one side of the extended region. If the extended bandwidth carrier 58 is double sided, the numbering continues in the second extended region side 56, starting with N+L₁ and continues up to N+L₁+L₂−1 where L₂ is the number of PRB pairs in the second extended region side 56.

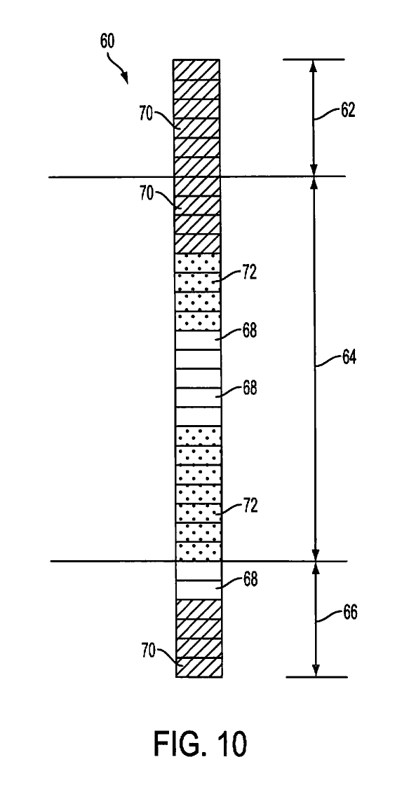

According to exemplary embodiments, FIG. 10 shows an example of scheduling for an extended bandwidth carrier using wrap around numbering. The extended carrier bandwidth 60 has a first extended bandwidth section 62, a legacy bandwidth 64 and a second extended bandwidth section 66. The extended bandwidth carrier 60 also includes empty PRBs 68, scheduled new UE PRBs 70 and scheduled legacy UE PRBs 72. Using this exemplary wrap around technique, indication of the scheduled resources in both ends of the extended bandwidth carrier 60 can occur with a contiguous resource allocation due to the wrap around numbering. If the scheduled PRBs for the new UE are not physically adjacent to each other, the resource allocation in the downlink control signaling can be simplified since they are adjacent in the PRB numbering domain. For instance, it can be sufficient to signal the start and end PRB number.

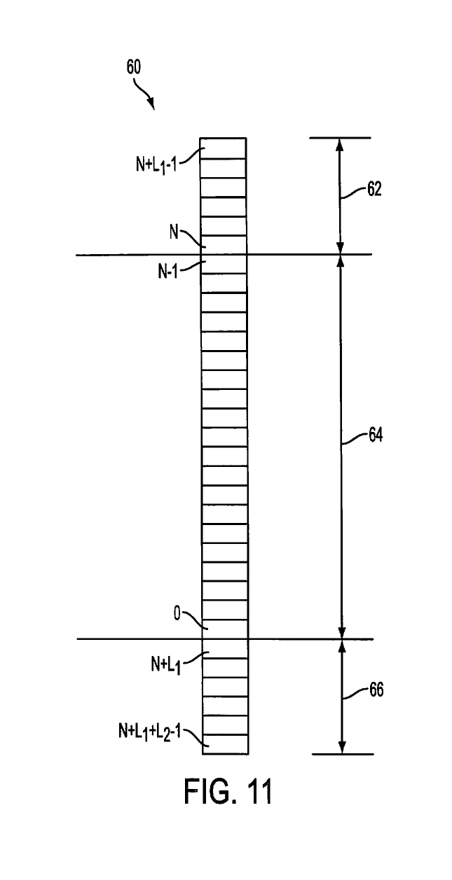

According to an alternative exemplary embodiment, the wrap around number can be inversed (as compared to previous embodiments) for the second extended bandwidth section 66 as shown in FIG. 11. This can be seen by comparing the numbering scheme associated with the extended region 56 shown in FIG. 9 to the numbering scheme associated with the second extended bandwidth section 66 as shown in FIG. 11. Using this exemplary alternative numbering scheme, a new UE can be scheduled with a large number of contiguous PRBs which can be centered on the legacy bandwidth 64, but still less wide than the full extended bandwidth.

According to exemplary embodiments, using a PRB pair numbering scheme which is common for both legacy and new UEs can allow for the backward compatibility. Also the exemplary PRB pair numbering scheme can allow for scheduling both the legacy and new UEs arbitrarily without restrictions despite having different system bandwidths. Furthermore, the exemplary PRB pair numbering scheme can provide transparency for new UEs with respect to whether the extended bandwidth carrier is single or double sided (due to the “wrap around” of the RB pair numbering) which simplifies and enables reuse of legacy methods, e.g., the scheduling for these new UEs.

According to an exemplary embodiment, a new UE can obtain the total legacy PRB size (N in the present example) from legacy control channels, e.g., the physical broadcast channel (PBCH) in LTE Rel-8. A new control signaling, in the form of either a common control channel or a dedicated control channel, can be communicated to the new UE to inform the new UE of the total extended PRB size and the actual physical configuration of the extended PRBs. One non-limiting exemplary control message format for this embodiment can be an integer pair where the first integer indicates the number of additional PRBs with frequencies above the legacy PRB region and the second integer indicates the number of additional PRBs with frequencies below the legacy PRB region.

For example, consider the extended bandwidth carrier 58 shown in FIG. 9. Therein the integer pair to be communicated to the new UE is [L1, L2], where L1 indicates additional PRBs with frequencies above the legacy PRB region and L2 indicates additional PRBs with frequencies below the legacy PRB region. For another example consider the extended bandwidth carrier 30 shown in FIG. 6. Therein the integer pair to be communicated to the new UE is (0, L), which indicates there is only one additional PRB region of size L with frequencies below the legacy PRB region.

According to another exemplary embodiment, another new control message, carried in the form of either a common control channel or a dedicated control channel, can be communicated to a new UE to inform the new UE of the physical configuration of the entire extended bandwidth carrier. One non-limiting exemplary control message format for this embodiment can be an integer triple where the first integer indicates the number of PRBs for the legacy bandwidth, the second integer indicates the number of additional PRBs with frequencies above the legacy PRB region and the third integer indicates the number of additional PRBs with frequencies below the legacy PRB region. For the example shown in FIG. 9, the integer triple communicated to a new UE is (N, L1, L2), indicating N PRBs for the legacy bandwidth, L1 additional PRBs with frequencies above the legacy PRB region and L2 additional PRBs with frequencies below the legacy PRB region. When using virtual resource blocks (VRBs), there can be a VRB numbering domain with the VRB corresponding to the extended region(s) being appended to the VRBs from the legacy region.

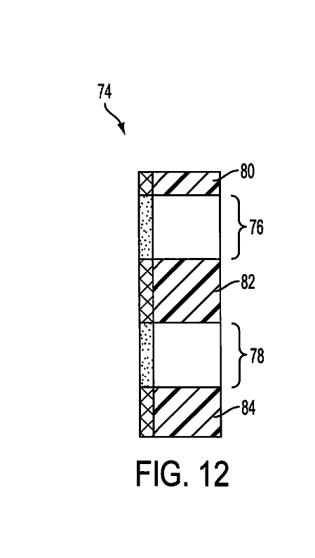

According to exemplary embodiments, there can be cases where it may be advantageous to have multiple legacy carriers within a single extended bandwidth carrier. FIG. 12 shows an example where two legacy bandwidth carriers 76 and 78 are embedded within the extended bandwidth carrier 74. New and legacy UEs can operate in the legacy bandwidth(s) 76 and 78 while only new UEs can operate in the extended non-legacy regions 80, 82 and 84 of the extended bandwidth carrier 74.

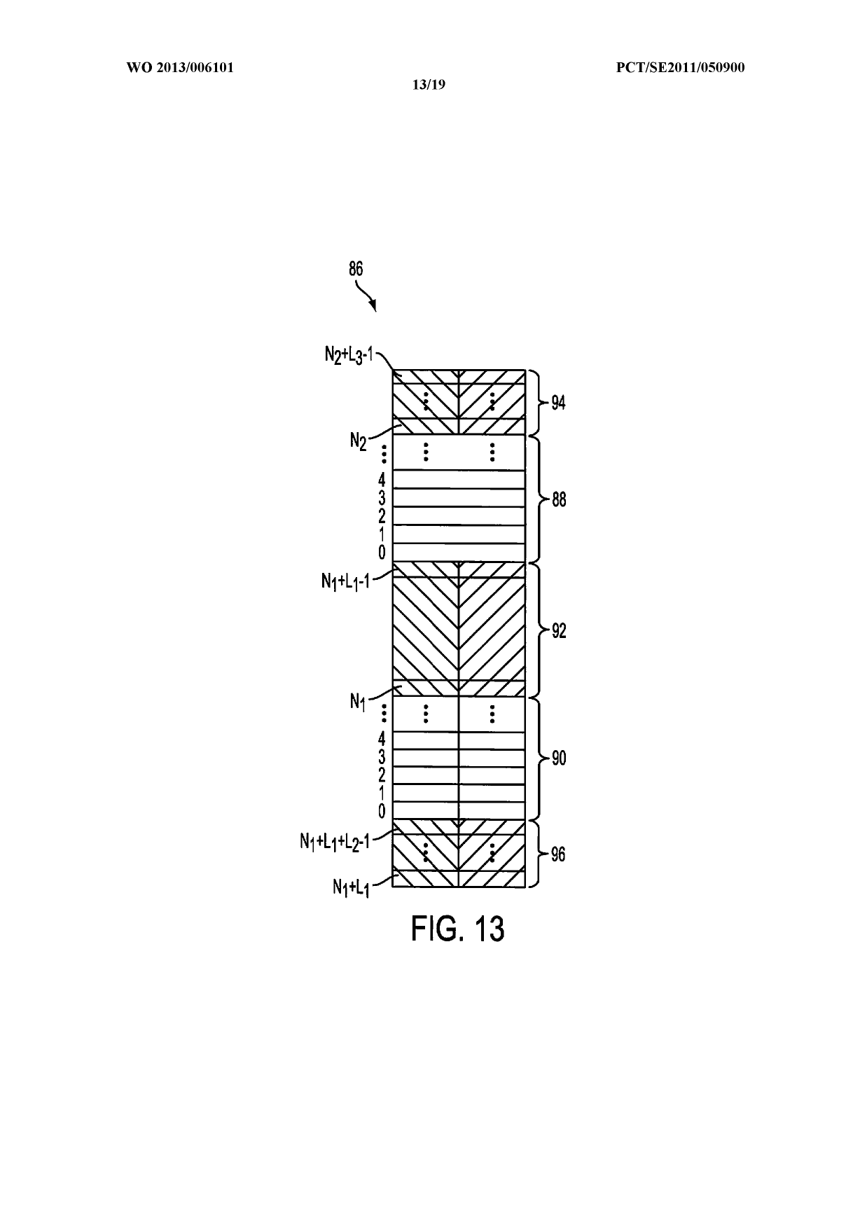

According to exemplary embodiments, PRB numbering in the case of multiple legacy carriers can be modified to maintain common PRB numbering across the whole extended bandwidth carrier. FIG. 13 shows an embodiment of PRB numbering with two legacy carriers 88 and 90 within the extended bandwidth carrier 86. In this example, the PRB numbering for a legacy carrier is extended to the additional control region that is higher in frequency than the legacy carrier. When there is an extended region that is not higher in frequency than any legacy carrier, the PRB numbering for the lowest frequency legacy carrier is extended cyclically as shown in the example associated with FIG. 9. To ensure that PRB numbering is unique, the PRB numbers can be prefixed with a flag CF, i.e., a carrier flag which indicates which legacy carrier the PRB is associated with.

Thus, according to exemplary embodiments as shown in FIG. 11, PRB numbering for the extended region labelled L₁ 92, in between the two extended carriers, can be carried out as an extension of the numbering for the legacy carrier N₁. Similarly, the highest extended region in frequency labelled L₃ 94, can be numbered as an extension of the legacy carrier N₂. The lowest frequency extended region labelled L₂ 96, can be numbered as a cyclic extension of the legacy carrier N₁ with the numbering continuing from the end of the extended region L₁, to the beginning of the region L₂. Thus, the legacy region N₁ and its two neighbouring extended regions can be numbered as shown FIG. 9. When referring to the PRB numbers the carrier flag prefix can be used to distinguish between the PRB numbers extended from the two legacy carriers. For example, PRB number 0 for each of the legacy carriers can be distinguished by referring to the carrier flag, e.g., CF1 and CF2 respectively.

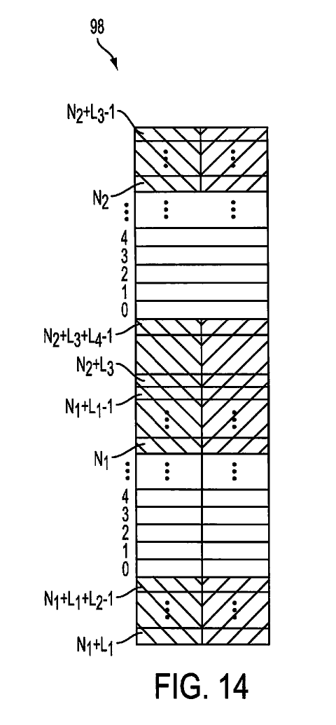

According to another exemplary embodiment, the association of the extended regions may be signalled explicitly to the UEs. In this case, the PRB numbering can be extended from a legacy carrier to its associated extension regions cyclically as shown in FIG. 9. An example of this is shown in FIG. 14, which has an extended bandwidth carrier 98 which includes extended regions L₁ and L₂ which are associated with legacy carrier N₁, and extended regions L₃ and L₄ which are associated with legacy carrier N₂.

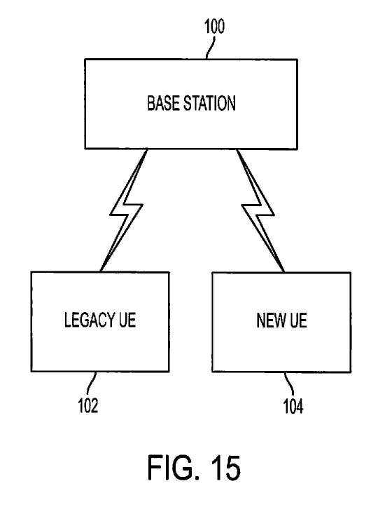

According to exemplary embodiments described herein there can be an extended bandwidth carrier which can include a legacy carrier. Portions of the extended bandwidth carrier can be used by legacy UEs and new UEs. Information describing the extended bandwidth carrier can be transmitted by a base station, e.g., an eNodeB, to both the legacy UEs and new UEs. An example of this is shown in FIG. 15, where a base station 100 is in communication with both a legacy UE 102 and a new UE 104.

Exemplary embodiments described herein provide for a number of various features to be realized in the context of legacy UEs, new UEs, base stations and various associated signaling. For example, exemplary embodiments provide for a control channel for new terminals with enhanced capacity and potentially reduced interference when the carrier is extended by segments. Exemplary embodiments enable the possibility to schedule a legacy and a new user equipment without restrictions, with the same (legacy) resource allocation method, despite their different system bandwidths. A separate control of control region size for extended region(s), including configuring no control (zero size) to cope with increased control resource demands when new terminals migrate into the system can exist. Additionally, an RB numbering method that is common for the legacy and new terminals in the legacy bandwidth and agnostic to the bandwidth and number of extensions/segments in the extended region (e.g. single/double sided extension) can be used.

Other examples include, providing the associated control signaling to inform the terminals about the configuration in said RB numbering method. Providing a means to have multiple legacy bandwidths within one carrier and providing the associated control signaling to inform the terminals how the carrier is configured can also be achieved by exemplary embodiments described herein. Also exemplary embodiments can allow for the ability to operate the system with a small legacy bandwidth within a large extended bandwidth which can be beneficial for energy saving reasons, when only the legacy bandwidth is active during off-peak hours.

According to exemplary embodiments, a method for using an extended bandwidth carrier includes the steps illustrated in FIG. 14. Therein, at step 106, receiving, at a transceiver, control signaling on the extended bandwidth carrier, the extended bandwidth carrier having a legacy bandwidth and additional resource blocks disposed outside of the legacy bandwidth and the extended bandwidth having: a first control region disposed within a legacy bandwidth shown in block 108; and a second control region disposed either within the legacy bandwidth or within the additional resource blocks shown in block 110, wherein the transceiver can receive the control signaling in either or both of the first control region and the second control region.

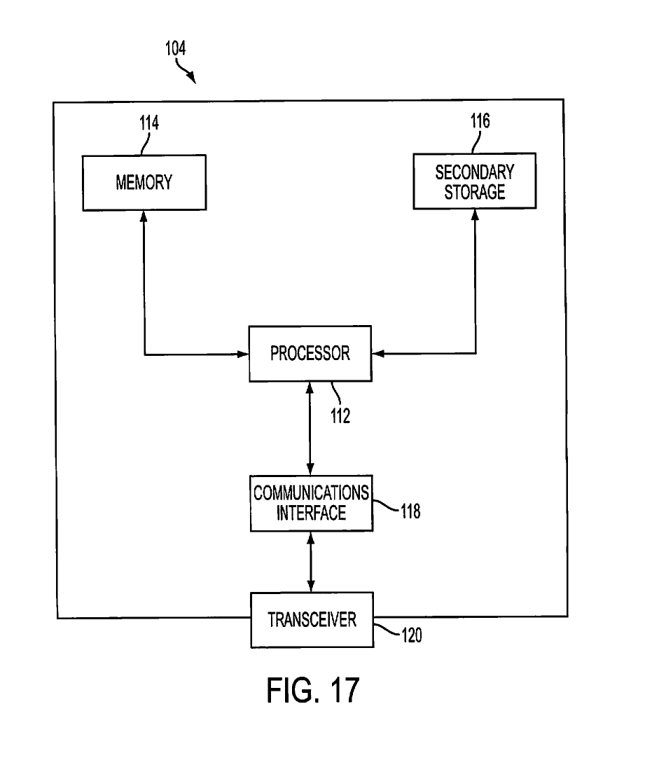

An exemplary new UE 104 which can either use, transmit, or receive signaling associated with an extended bandwidth carrier is generically illustrated in FIG. 17. The new UE 104 can contain a processor 112 (or multiple processor cores), memory 114, one or more secondary storage devices 116, a communications interface unit 118 to facilitate communications and a transceiver 120. The processor 114 is configured to understand received instructions for using the extended bandwidth carrier. Memory 116 can be used to store information associated with using the extended bandwidth carrier, e.g., implementing or understanding the PRB numbering scheme. Additionally, the communications interface unit 118 and the transceiver 120 can be configured for transmitting/receiving messages associated with a new control channel(s) and/or the extended bandwidth carrier, e.g., associated with aspects such as modulation/demodulation frequencies, filtering bandwidths, and the like. Thus, the new UE 104 can perform the exemplary embodiments described herein associated with a new UE 104.

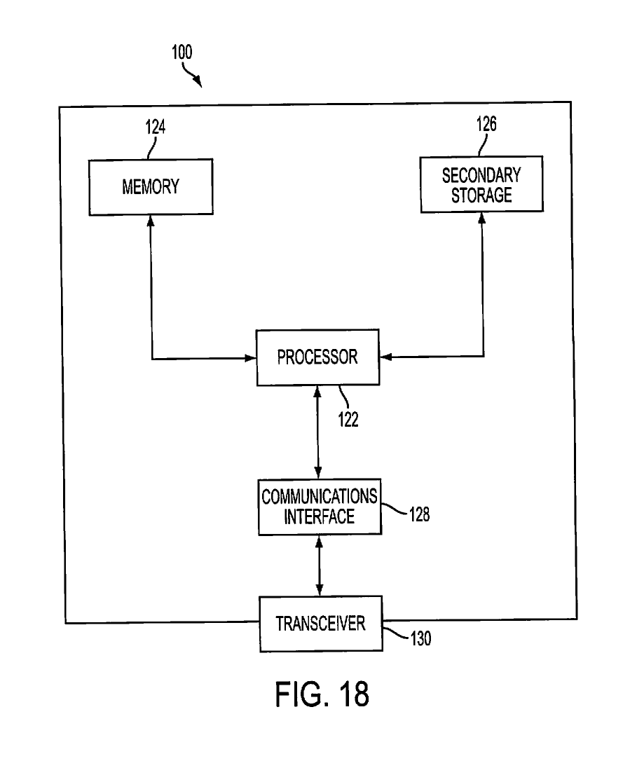

An exemplary base station 100 which can either use, transmit, or receive signaling associated with an extended bandwidth carrier is generically illustrated in FIG. 18. The base station 100 can contain a processor 122 (or multiple processor cores), memory 124, one or more secondary storage devices 126, a communications interface unit 128 to facilitate communications and a transceiver 130. The processor 122 is configured to transmit instructions describing the extended bandwidth carrier and understand received information on the extended bandwidth carrier from one or more new UEs 104. Memory 124 can be used to store information associated with using the extended bandwidth carrier, e.g., implementing or understanding the PRB numbering scheme. Additionally, the communications interface unit 128 and the transceiver 130 can be configured for transmitting/receiving messages associated with a new control channel(s) and/or the extended bandwidth carrier, e.g., associated with aspects such as modulation/demodulation frequencies, filtering bandwidths, and the like. Thus, the base station 100 can perform the exemplary embodiments described herein from its point of view.

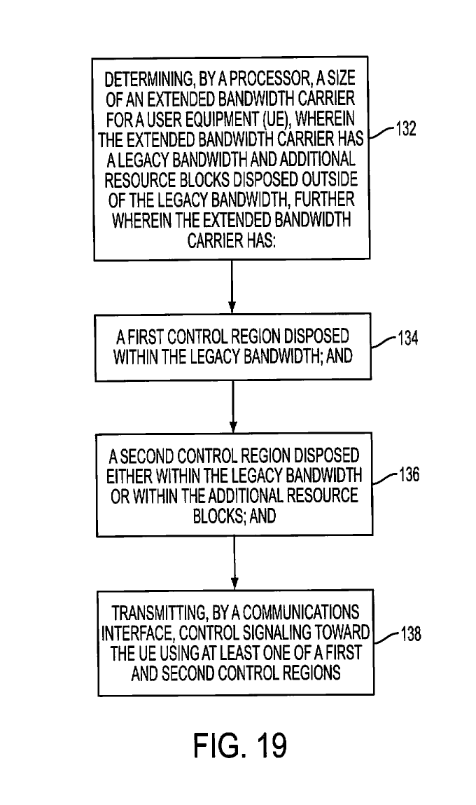

According to exemplary embodiments, a method for a base station to use an extended bandwidth carrier includes the steps illustrated in FIG. 19. Therein, at step 132 determining, by a processor, a size of an extended bandwidth carrier for a user equipment (UE), wherein the extended bandwidth carrier has a legacy bandwidth and additional resource blocks disposed outside of the legacy bandwidth, further wherein the extended bandwidth carrier has: a first control region disposed within the legacy bandwidth as shown in block 134; and a second control region disposed either within the legacy bandwidth or within the additional resource blocks as shown in block 136; and at step 138 transmitting, by a communications interface, control signaling toward the UE using at least one of a first and second control regions.

The above-described embodiments are intended to be illustrative in all respects, rather than restrictive, of the present invention. All such variations and modifications are considered to be within the scope of the present invention as defined by the following claims. For example, other variations for associating extended regions to legacy carriers implicitly or explicitly and for extending PRB numbering are possible. No element, act, or instruction used in the description of the present application should be construed as critical or essential to the invention unless explicitly described as such. Also, as used herein, the article “a” is intended to include one or more items.

What is claimed is:

1. A user equipment (UE) (104) characterized in that:
a transceiver (120) configured to receive control signaling on an extended bandwidth carrier (18), the extended bandwidth carrier (18) having a legacy bandwidth (22) and additional resource blocks (28) disposed outside of the legacy bandwidth (22) and the extended bandwidth carrier (18) having:
a first control region (50) disposed within the legacy bandwidth; and
a second control region (48) disposed either within the legacy bandwidth or within the additional resource blocks,
wherein the transceiver (120) can receive the control signaling in either or both of the first control region (50) and the second control region (48).

2. The UE of claim 1, wherein two legacy bandwidths are used with each legacy bandwidth having adjacent, additional resource blocks.

3. The UE of claims 1-2, wherein physical resource block (PRB) pairs are numbered in the legacy bandwidth and a common numbering scheme continues through both the legacy bandwidth and the additional resource blocks in either a frequency increasing or a frequency decreasing direction.

4. The UE of claims 1-3, wherein the second control region is disposed inside the legacy bandwidth, wherein the second control region is not disposed within a legacy control region.

5. The UE of claims 1-3, wherein the second control region is disposed within the additional resource blocks.

6. The UE of claims 1-5, further comprising:
a communications interface configured to receive control signaling describing a manner in which the extended bandwidth carrier is configured.

7. The UE of claims 1-6, wherein the control signaling is received by the UE on one of a common control channel or a dedicated control channel.

8. The UE of claims 1-7, wherein the received control signaling includes a message which includes an integer triple with a first integer indicating the number of physical resource block (PRB) pairs for the legacy bandwidth, a second integer indicating the number of additional PRBs with frequencies above the legacy bandwidth frequency and a third integer indicating the number of additional PRBs with frequencies below the legacy bandwidth frequency.

9. The UE of claims 1-9, wherein the legacy bandwidth includes a bandwidth of at least one of 6, 15, 25, 50, 75 and 100 resource blocks in size, wherein a resource block corresponds to one slot in a time domain and twelve contiguous subcarriers in a frequency domain.

10. A method for a user equipment (UE) (104) to use an extended bandwidth carrier, characterized in that:
receiving, at a transceiver, control signaling on the extended bandwidth carrier, the extended bandwidth carrier having a legacy bandwidth and additional resource blocks disposed outside of the legacy bandwidth and the extended bandwidth carrier having (106):
a first control region disposed within the legacy bandwidth; and
a second control region disposed either within the legacy bandwidth or within the additional resource blocks (110),
wherein the transceiver can receive the control signaling in either or both of the first control region and the second control region.

11. The method of claim 10, further comprising:
using two legacy bandwidths with each legacy bandwidth having adjacent, additional resource blocks.

12. The method of claims 10-11, wherein physical resource block (PRB) pairs are numbered in the bandwidth and a common numbering scheme continues through both the legacy bandwidth and the additional resource blocks in either a frequency increasing or a frequency decreasing direction.

13. The method of claims 10-12, further comprising:
disposing the second control region inside the legacy bandwidth, wherein the second control region is not disposed within a legacy control region.

14. The method of claims 10-12, further comprising:
disposing the second control region within the additional resource blocks.

15. The method of claims 10-14, further comprising:
receiving, by a communications interface, control signaling describing how the extended bandwidth carrier is configured.

16. The method of claims 10-15, wherein the control signaling is received by the UE on one of a common control channel or a dedicated control channel.

17. The method of claims 10-16, wherein the received control signaling includes a message which includes an integer triple with a first integer indicating the number of physical resource block (PRB) pairs for the legacy bandwidth, a second integer indicating the number of additional PRBs with frequencies above the legacy bandwidth frequency and a third integer indicating the number of additional PRBs with frequencies below the legacy bandwidth frequency

18. The method of claims 10-17, wherein the legacy bandwidth includes a bandwidth of at least one of 6, 15, 25, 50, 75 and 100 resource blocks in size, wherein a resource block corresponds to one slot in a time domain and twelve contiguous subcarriers in a frequency domain.

19. A base station (100) comprising:
a processor (122) configured to determine a size of an extended bandwidth carrier (18) for a user equipment (UE) (104), wherein the extended bandwidth carrier (18) has a legacy bandwidth (22) and additional resource blocks (28) disposed outside of the legacy bandwidth (22), further wherein the extended bandwidth carrier (18) has:
a first control region (50) disposed within the legacy bandwidth;
a second control region (48) disposed either within the legacy bandwidth or within the additional resource blocks; and
a communications interface (130) configured to transmit control signaling toward the UE (104) using at least one of a first and second control regions.

20. The base station of claim 19, wherein the control signaling describes a manner in which the extended bandwidth carrier is configured.

21. The base station of claims 19-20, wherein the second control region is disposed inside the legacy bandwidth.

22. The base station of claims 19-20, wherein the second control region is disposed within the additional resource blocks.

23. The base station of claims 19-21, wherein the control signaling is transmitted on one of a common control channel or a dedicated control channel.

24. The base station of claims 19-23, wherein the transmitted control signaling includes a message which includes an integer triple with a first integer indicating the number of physical resource block (PRB) pairs for the legacy bandwidth, a second integer indicating the number of additional PRBs with frequencies above the legacy bandwidth frequency and a third integer indicating the number of additional PRBs with frequencies below the legacy bandwidth frequency.

25. The base station of claims 19-24, wherein the additional resource blocks are dynamically added to both sides of the legacy bandwidth.

26. The base station of claims 19-24, wherein the additional resource blocks are dynamically added on one side of the legacy bandwidth.

27. The base station of claims 19-26, wherein the base station is an eNodeB.

28. The base station of claims 19-27, wherein the legacy bandwidth includes a bandwidth of at least one of 6, 15, 25, 50, 75 and 100 resource blocks in size, wherein a resource block corresponds to one slot in a time domain and twelve contiguous subcarriers in a frequency domain.

29. A method for a base station (100) to use an extended bandwidth carrier, the method comprising:
determining, by a processor, a size of an extended bandwidth carrier for a user equipment (UE), wherein the extended bandwidth carrier has a legacy bandwidth and additional resource blocks disposed outside of the legacy bandwidth, further wherein the extended bandwidth carrier has:
a first control region disposed within the legacy bandwidth; and
a second control region disposed either within the legacy bandwidth or within the additional resource blocks; and
transmitting, by a communications interface, control signaling toward the UE using at least one of a first and second control regions.

30. The method of claim 29, wherein the control signaling describes a manner in which the extended bandwidth carrier is configured.

31. The method of claims 29-30, further comprising:
disposing the second control region inside the legacy bandwidth.

32. The method of claims 29-30, further comprising:
disposing the second control region within the additional resource blocks.

33. The method of claims 29-32, further comprising:
transmitting the control signaling on one of a common control channel or a dedicated control channel.

34. The method of claims 29-33, wherein the transmitted control signaling includes a message which includes an integer triple with a first integer indicating the number of physical resource block (PRB) pairs for the legacy bandwidth, a second integer indicating the number of additional PRBs with frequencies above the legacy bandwidth frequency and a third integer indicating the number of additional PRBs with frequencies below the legacy bandwidth frequency.

35. The method of claims 29-34, further comprising:
dynamically adding the additional resource blocks to both sides of the legacy bandwidth.

36. The method of claims 29-34, further comprising:
dynamically adding the additional resource blocks are on one side of the legacy bandwidth.

37. The method of claims 29-36, wherein the base station is an eNodeB.

38. The method of claims 39-37, wherein the legacy bandwidth includes a bandwidth of at least one of 6, 15, 25, 50, 75 and 100 resource blocks in size, wherein a resource block corresponds to one slot in a time domain and twelve contiguous subcarriers in a frequency domain.
